(19) United States
(12) Patent Application Publication
(10) Pub. No.: US 2023/0130977 A1
(43) Pub. Date: Apr. 27, 2023

(54) ROBOT CONTROL METHOD, ROBOT AND COMPUTER-READABLE STORAGE MEDIUM

(71) Applicant: UBTECH ROBOTICS CORP LTD, Shenzhen (CN)

(72) Inventors: Xianwen Zeng, Shenzhen (CN); Yizhang Liu, Shenzhen (CN); Meihui Zhang, Shenzhen (CN); Jinliang Chen, Shenzhen (CN); Youjun Xiong, Shenzhen (CN)

(21) Appl. No.: 18/089,614

(22) Filed: Dec. 28, 2022

Related U.S. Application Data
(63) Continuation of application No. PCT/CN2020/139890, filed on Dec. 28, 2020.

(30) Foreign Application Priority Data
Dec. 7, 2020 (CN) 202011416299.0

(51) Int. Cl. B25J 9/16; B25J 13/08

(52) U.S. Cl. CPC B25J 9/1607; B25J 9/1633; B25J 9/1664; B25J 13/085

(57) ABSTRACT

A method for controlling a robot comprising an end effector includes: establishing at steady state between the end effector and a working surface through a preset impedance control mechanism, and adjusting a contact force between the end effector and the working surface according to a preset desired force; obtaining a contact torque generated by the contact force; controlling the end effector to rotate according to the contact torque until a pose of the end effector is consistent with a pose of the working surface; and controlling the end effector to move tangentially along the working surface.

### CROSS REFERENCE TO RELATED APPLICATIONS

The present application is a continuation-application of International Application PCT/CN2020/139890, with an international filing date of Dec. 28, 2020, which claims foreign priority of Chinese Patent Application No. 202011416299.0, filed on Dec. 7, 2020 in the China National Intellectual Property Administration, the contents of all of which are hereby incorporated by reference.

### BACKGROUND

### 1. Technical Field

The present disclosure generally relates to robots, and particularly to a robot control method, robot, and a computer-readable storage medium.

### 2. Description of Related Art

Robots have been widely applied in many fields, and the tasks they face no longer require only position control. When performing robot grinding, assembly operations, human body massage, and rehabilitation services, force control and position control of robot are required. The above-mentioned operations often suffer from the problem of unknown working environment. On the one hand, the position information of the surface of the working object relative to the robot is unknown, and the mechanical properties of the working object are unknown, resulting in the inability to achieve effective adjustment of contact force. On the other hand, due to the unknown environment pose in task trajectory planning, it may cause a large contact force error when the planned trajectory cannot adapt to the environment pose.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a robot according to one embodiment.

FIG. 2 is an exemplary flowchart of a robot control method according to one embodiment.

FIG. 3 is a schematic diagram of a position-based impedance control mechanism.

FIG. 4 is a schematic diagram showing the pose of the end effector being inconsistent with the pose of the working surface.

FIG. 5 is a schematic diagram showing the pose of the end effector being consistent with the pose of the working surface.

FIG. 6 is a schematic block diagram of a robot control device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

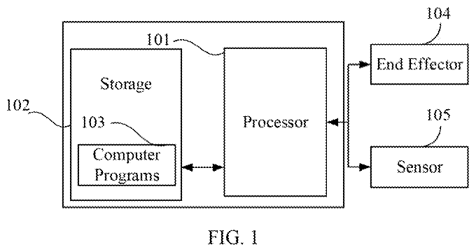

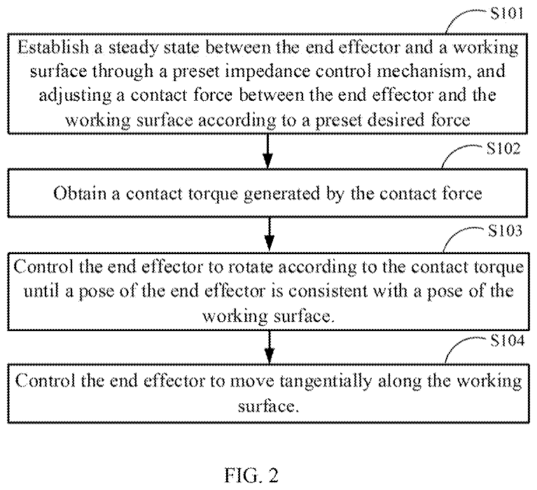

FIG. 1 shows a schematic block diagram of a robot 10 according to one embodiment. The robot may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of the method for controlling the robot, such as steps S104 to S104 in FIG. 2, are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the robot, such as a hard disk or a memory. The storage 102 may also be an external storage device of the robot, such as a plug-in hard disk, a smart memory card (SMC), and a secure digital (SD) card, or any suitable flash cards. Furthermore, the storage 102 may also include both an internal storage unit and an external storage device. The storage 102 is used to store computer programs, other programs, and data required by the robot. The storage 102 can also be used to temporarily store data that have been output or is about to be output.

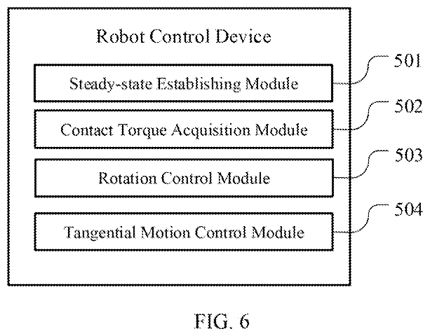

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the robot. For example, the one or more computer programs 103 may be divided into a steady-state establishing module 501, a contact torque acquisition module 502, a rotation control module 503, and a tangential motion control module 504 as shown in FIG. 6.

In one embodiment, the robot further includes an end effector 104 and a sensor 105 that are electrically connected to the processor 101.

It should be noted that the block diagram shown in FIG. 1 is only an example of the robot. The robot may include more or fewer components than what is shown in FIG. 1, or have a different configuration than what is shown in FIG. 1. Each component shown in FIG. 1 may be implemented in hardware, software, or a combination thereof.

Referring to FIG. 2, in one embodiment, a robot control method may include the following steps.

Step S101: Establish a steady state between the end effector and a working surface through a preset impedance control mechanism, and adjusting a contact force between the end effector and the working surface according to a preset desired force.

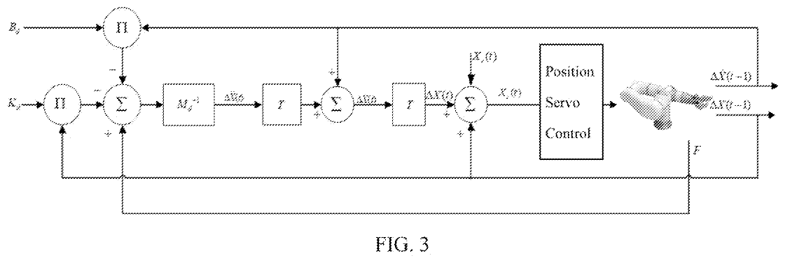

Referring to FGI. 3, in one embodiment, the estimation of the environment poses and the control of the contact force is implemented on the basis of a position-based impedance control mechanism shown in FIG. 3.

Specifically, a reference position of the end effector (denoted as Xᵣ) can be obtained first, and the contact force (denoted as F) between the end effector and the surface of the working environment (hereinafter referred to as “working surface”) is measured by the sensor 105 of the robot. The reference position may be the current actual position of the end effector.

Then, by inputting the contact force into a preset impedance control equation, the position compensation amount of the end effector (denoted as ΔX) can be calculated. The command position (denoted as X_{c}) of the end effector can be calculated according to the position compensation amount and the reference position, namely: X_{c}−X, +ΔX.

Then, the command position is input into a preset position servo controller to control the movement of the end effector.

It should be noted that the establishment of a steady state between the end effector and the working surface can be a process of continuous iterative updating, and the above-mentioned steps are only one cycle. The step of obtaining the reference position of the end effector and its subsequent steps may need to be repeatedly executed until the preset steady-state condition is met. The steady-state condition is that the contact force is equal to the desired force (denoted as F_{d}), that is, F=F_{d}. The desired force is the adjustment expectation for the contact force, which can be set according to actual needs.

The specific impedance control equation to be used may be set according to actual needs, which is not specifically limited. In one embodiment, the following adaptive impedance control equation can be used: M_{d}(\ddot{X}_{c}−\ddot{X}ᵣ)+B_{d}(\dot{X}_{c}−\dot{X}ᵣ)=F−F_{d}, where M_{d} is a preset inertia matrix, B_{d} is a preset damping matrix, and F_{d} is the desired force. In this impedance control equation, the stiffness term (denoted as K_{d}) is set to zero.

Through the above-mentioned impedance control mechanism, the steady state between the end effector and the working surface can be established in the face of any varying environmental stiffness without obtaining an accurate initial position of the working surface.

Step S102: Obtain a contact torque generated by the contact force.

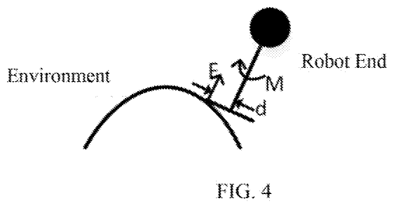

As shown in FIG. 4, when the end effector is in contact with the working surface, since the pose of the end effector is inconsistent with the pose of the working surface, the contact force will generate a torque, that is, the contact torque. In one embodiment, the contact torque (denoted as M) can be directly obtained through a preset six-dimensional force sensor.

Step S103: Control the end effector to rotate according to the contact torque until a pose of the end effector is consistent with a pose of the working surface.

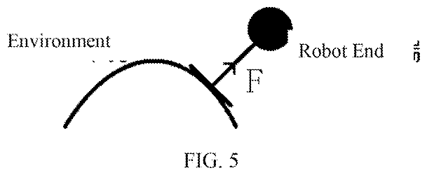

During this process, the end effector can be controlled to rotate to gradually reduce the contact torque. When the contact torque is 0, it can be determined that the pose of the end effector is consistent with the pose of the working surface, as shown in FIG. 5.

In one embodiment, the impedance control mechanism can be used to adjust the contact torque, and the contact torque is adjusted according to a preset desired torque. The desired torque is the adjustment expectation for the contact torque, which is set to 0 here. When performing impedance control, it needs to replace the contact force in the impedance control equation with the contact torque, and replace the desired force with the desired torque. When M=0, it can be determined that the pose of the end effector is consistent with the pose of the working surface, thereby completing the estimation of the environment pose.

Step S104: Control the end effector to move tangentially along the working surface.

Specifically, the first coordinates of the trajectory point of the end effector at the next moment may be determined first, and the first coordinates are coordinates in an end coordinate system.

Then, the first coordinates are transformed according to the pose of the end effector to obtain the second coordinates of the trajectory point of the end effector at the next moment, and the second coordinates are coordinates in a base coordinate system. In one embodiment, the second coordinates can be calculated according to the following equation:

$${base}^{} {x}_{next \_ point} = {}_{end}^{base} R \cdot {end}^{} {x}_{next \_ point} ,$$

where end_{X}_{_{next_point}} represents the first coordinates, base_{end}R represents the pose of the end effector, and base_{X}_{_{next_point represents the second coordinates.}}

Finally, the end effector can be controlled to move along the tangential direction of the working surface according to the second coordinates. The second coordinates are input into the position servo controller to control the end effector to move tangentially along the working surface, so as to avoid contact force errors caused by the movement direction not conforming to the environment pose.

In summary, according to the method of the above-mentioned embodiments, the following operations are performed: establishing a steady state between the end effector and a working surface through a preset impedance control mechanism, and adjusting a contact force between the end effector and the working surface according to a preset desired force; obtaining a contact torque generated by the contact force; controlling the end effector to rotate according to the contact torque until a pose of the end effector is consistent with a pose of the working surface; and controlling the end effector to move tangentially along the working surface. With the method above, even in the face of an unknown working environment, the contact force can be effectively adjusted, and a task trajectory planning that adapts to the environment pose can be performed, thereby effectively reducing the error of the contact force.

It should be understood that sequence numbers of the foregoing processes do not mean an execution sequence in this embodiment of this disclosure. The execution sequence of the processes should be determined according to functions and internal logic of the processes, and should not be construed as any limitation on the implementation processes of this embodiment of this disclosure.

Corresponding to the robot control method described in the embodiments above, FIG. 6 shows a schematic block diagram of a robot control device. In one embodiment, the robot control device may include a steady-state establishing module 501, a contact torque acquisition module 502, a rotation control module 503, and a tangential motion control module 504. The steady-state establishing module 501 is to establish a steady state between the end effector and a working surface through a preset impedance control mechanism, and adjust a contact force between the end effector and the working surface according to a preset desired force. The contact torque acquisition module 502 is to obtain a contact torque generated by the contact force. The rotation control module 503 is to control the end effector to rotate according to the contact torque until a pose of the end effector is consistent with a pose of the working surface. The tangential motion control module 504 is to control the end effector to move tangentially along the working surface.

In one embodiment, the steady-state establishing module 501 may include a contact force measuring unit, a position compensation calculation unit, a command position calculation unit, and a command position input unit. The contact force measuring unit is to obtain a reference position of the end effector, and measure the contact force between the end effector and the working surface through a sensor of the robot. The position compensation calculation unit is to input the contact force into a preset impedance control equation to calculate a position compensation amount for the end effector. The command position calculation unit is to calculate a command position of the end effector according to the position compensation amount and the reference position. The command position input unit is to input the command position into a preset position servo controller to control the movement of the end effector.

In one embodiment, the rotation control module 503 may include a rotation control unit and a pose determination unit. The rotation control unit is to control the end effector to rotate to gradually reduce the contact torque. The pose determination unit is to, in response to the contact torque being equal to 0, determine that the pose of the end effector is consistent with the pose of the working surface.

In one embodiment, the tangential motion control module 504 may include a first coordinate determination unit, a coordinate converting unit, and a tangential motion control unit. The first coordinate determination unit is to determine first coordinates of a trajectory point of the end effector at a next moment. The first coordinates are coordinates in an end coordinate system. The coordinate converting unit is to convert the first coordinates according to the pose of the end effector to obtain second coordinates of the trajectory point of the end effector at the next moment. The second coordinates are coordinates in a base coordinate system. The tangential motion control unit is to control the end effector to move tangentially along the working surface according to the second coordinates.

The coordinate converting unit is to calculate the second coordinates according to the following equation:

$${base}^{} {x}_{next \_ point} = {}_{end}^{base} R \cdot {end}^{} {x}_{next \_ point} ,$$

where
where end_{X}_{_{next_point}} represents the first coordinates, base_{end}R represents the pose of the end effector, and base_{X}_{_{next_point represents the second coordinates.}}

In one embodiment, an impedance control equation used in the impedance control mechanism is as follows: M_{d}(\ddot{X}_{c}−\ddot{X}ᵣ)+B_{d}(\dot{X}_{c}−\dot{X}ᵣ)=F−F_{d}, where M_{d} is a preset inertia matrix, B_{d} is a preset damping matrix, Xᵣ is a reference position of the end effector, X_{c} is a commend position of the end effector, F is the contact force, and F_{d} is the desired force.

It should be noted that the basic principles and technical effects of the robot control device are the same as the aforementioned method. For a brief description, for parts not mentioned in this device embodiment, reference can be made to corresponding description in the method embodiments.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module / unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The embodiments above are only illustrative for the technical solutions of the present disclosure, rather than limiting the present disclosure. Although the present disclosure is described in detail with reference to the above embodiments, those of ordinary skill in the art should understand that they still can modify the technical solutions described in the foregoing various embodiments, or make equivalent substitutions on partial technical features; however, these modifications or substitutions do not make the nature of the corresponding technical solution depart from the spirit and scope of technical solutions of various embodiments of the present disclosure, and all should be included within the protection scope of the present disclosure.

What is claimed is:

1. A computer-implemented method for controlling a robot comprising an end effector, the method comprising:
establishing a steady state between the end effector and a working surface through a preset impedance control mechanism, and adjusting a contact force between the end effector and the working surface according to a preset desired force;
obtaining a contact torque generated by the contact force;
controlling the end effector to rotate according to the contact torque until a pose of the end effector is consistent with a pose of the working surface; and
controlling the end effector to move tangentially along the working surface.

2. The method of claim 1, wherein establishing the steady state between the end effector and the working surface through the preset impedance control mechanism comprises:
a) obtaining a reference position of the end effector, and measuring the contact force between the end effector and the working surface through a sensor of the robot;
b) inputting the contact force into a preset impedance control equation to calculate a position compensation amount for the end effector;
c) calculating a command position of the end effector according to the position compensation amount and the reference position;
d) inputting the command position into a preset position servo controller to control the movement of the end effector; and
e) repeating a) to e) until a preset steady-state condition is met.

3. The method of claim 1, wherein obtaining a contact torque generated by the contact force comprises:
obtaining the contact torque generated by the contact force through a preset six-dimensional force sensor.

4. The method of claim 1, wherein controlling the end effector to rotate according to the contact torque until a pose of the end of is consistent with a pose of the working surface, comprises:
controlling the end effector to rottite to gradually reduce the contact torque, and
in response to the contact torque being equal to 0, determining that the pose of the end effector is consistent with the pose of the working surface.

5. The method of claim 1, wherein controlling the end effector to move tangentially along the working surface comprises:
determining first coordinates of a trajectory point of the end effector at a next moment, wherein the first coordinates are coordinates in an end coordinate system;
converting the first coordinates according to the pose of the end effector to obtain second coordinates of the trajectory point of the end effector at the next moment, wherein the second coordinates are coordinates in a base coordinate system; and
controlling the end effector to move tangentially ong the working surface according to the second coordinates.

6. The method of claim 5, wherein converting the first coordinates according to the pose of the end effector to obtain second coordinates of the trajectory point of the end effector at the next moment, comprises:
calculating the second coordinates according to the following equation:
$${base}^{} {x}_{next \_ point} = {}_{end}^{base} R \cdot {end}^{} {x}_{next \_ point} ,$$
where end_{X}_{_{next_point}} represents the first coordinates, base_{end}R represents the pose of the end elector, and base_{X}_{_{next_point}} represents the second coordinates.

7. The method of claim 1. wherein an impedance control equation used in the impedance control mechanism is as follows: M_{d}(\ddot{X}_{c}−\ddot{X}ᵣ)+B_{d}(\dot{X}_{c}−\dot{X}ᵣ)=F−F_{d}, where M_{d} is a preset inertia matrix, B_{d} is a preset damping matrix, Xᵣ is a reference position of the end effector, X_{c} is a commend position of the end effector, F is the contact force, and F_{d} is the desired force.

8. A robot comprising:
an end effector:
one or more processors; and
a memory coupled to the one or more processors, the memory storing programs that, when executed by the one or more processors, cause performance of operations establishing a steady state between tine end effector and a working surface through a preset impedance control mechanism, and adjusting a contact force between the end effector and the working surface according to a preset desired force;
obtaining a contact torque generated by the contact force;
controlling the end effector to rotate according to the contact torque until a pose of the end effector is consistent with a pose of the working surface; and
controlling the end effector to move tangentially along the working surface.

9. The robot of claim 8, wherein establishing the steady state between the end effector and the working surface through the preset impedance control mechanism comprises:
a) obtaining a reference position of the end effector, and measuring the contact force between the end effector raid the working surthce through a sensor at the robot;
b) inputting the contact force into a preset impedance control equation to calculate a position compensation amount for the end effector;
c) calculating a command position of the end effector according to the position compensation amount and the reference position;
d) inputting the command position into a preset position servo controller to control the movement of the end effector; and
e) repeating a) to e) until a preset steady-state condition is met.

10. The method of claim 8, wherein obtaining a contact torque generated by the contact force comprises:
obtaining the contact torque generated by the contact force through a preset six-dimensional force sensor.

11. The robot of claim 8, wherein controlling the end effector to rotate according to the contact torque until a pose of the end effector is consistent with a pose of the working surface, comprises:
controlling the end effector to rotate to gradually reduce tl e contact torque; and
in response to the contact torque being equal to 0 determining that the pose of the end effector is consistent with the pose. of the working surface.

12. The robot of claim 8, wherein controlling the end effector to move tangentially along the working surface comprises:
determining first coordinates of a trajectory point of the end etTector at a next moment, wherein the first coordinates are coordinates in an end coordinate system;
converting the first coordinates according to the pose of the end effector to obtain second coordinates of the trajectory point of the end effector at the next moment, wherein the second coordinates are coordinates in a base coordinate system; and
controlling the end effector to move tangentially along the working surface according to the second coordinates.

13. The robot of claim 12, wherein converting, the first coordinates according to the pose of the end effector to obtain second coordinates of the trajectory point of the end effector at the next moment, comprises:
calculating the second coordinates according to the following equation:
$${base}^{} {x}_{next \_ point} = {}_{end}^{base} R \cdot {end}^{} {x}_{next \_ point} ,$$
where end_{X}_{_{next_point}} represents the first coordinates, base_{end}R represents the pose of the end elector, and base_{X}_{_{next_point}} represents the second coordinates.

14. The robot of claim 8, wherein an impedance control equation used in the impedance control mechanism is as follows: M_{d}(\ddot{X}_{c}−\ddot{X}ᵣ)+B_{d}(\dot{X}_{c}−\dot{X}ᵣ)=F−F_{d}, where M_{d} is a preset inertia matrix, B_{d} is a preset damping matrix, Xᵣ is a reference position of the end effector, X_{c} is a commend position of the end effector, F is the contact force, and F_{d} is the desired force.

15. A non-transitory computer-readable storage medi tun storing instructions that, when executed by at least one processor of a robot comprising an end effector, cause the at least one processor to perform a robot control method, the method comprising:
establishing a steady sta e lbetween etweeta the end effector and a working surface through a preset impedance control mechanism, and adjusting a contact force between the end effector and the working surface according to a preset desired force;
obtaining a contact torque generated by- the contact tbrce;
controlling the end effector to rotate according to the contact torque until a pose of the end effector is consistent with a pose of the working surface; and
controlling the end effector to move tangentially along the working surface.

16. The non-transitory computer-readable storage medium of claim 15, wherein establishing the steady state between the end effector and the working surface through the preset impedance control mechanism comprises:
a) obtaining a reference position of the end effector, and measuring the contact force between the end effector and the working surface through a sensor of the robot;
b) inputting the contact force into a preset impedance control equation to calculate a position compensation amount for the end effector;
c) calculating a command position of the end effector according to the position compensation amount and the reference position;
d) inputting the command position into a preset position servo controller to control the movement of the end effector, and
e) repeating, a) to e) until a preset steady-state condition is met.

17. The non-transitory computer-readable storage medium of claim 15, wherein obtaining, a contact torque generated by the contact force comprises:
obtaining the contact torque generated by the contact force through a preset six-dimensional force sensor.

18. The non-transitory computer-readable storage medium of claim 15, wherein controlling the end effector to rotate according to the contact torque until a pose of the end effector is consistent with a pose of the working surface, comprises:
controlling the end effector to rotate to gradually reduce the contact torque; and in response to the contact torque being equal to 0, determining that the pose of the end effector is consistent with the pose of the working surface.

19. The non-transitory computer-readable storage medium of claim 15, wherein controlling the end effector to move tangentially along the working surface comprises:
determining, first coordinates of a trajectory point of the end effector at a next moment, wherein the first coordinates are coordinates in an end coordinate system;
converting the first coordinates according to the pose of the end effector to obtain second coordinates of the trajectory point of the end effector at the next moment, wherein the second coordinates are coordinates in a base coordinate system; and
controlling the end effector to move tangentially along the working surface according to the second coordinates.

20. The non-transitory computer-readable storage medium of claim 19, wherein converting, the first coordinates according to the pose of the end effector to obtain second coordinates of the trajectors point of the end effector at the next moment, comprises:
calculating the second coordinates according to the following equation:
$${base}^{} {x}_{next \_ point} = {}_{end}^{base} R \cdot {end}^{} {x}_{next \_ point} ,$$
where end_{X}_{_{next_point}} represents the first coordinates, base_{end}R represents the pose of the end elector, and base_{X}_{_{next_point}} represents the second coordinates.
